(19) United States
(12) Patent Application Publication
(10) Pub. No.: US 2025/0217620 A1
(43) Pub. Date: Jul. 3, 2025

(54) DATA PROCESSING METHOD AND APPARATUS, AND ELECTRONIC DEVICE

(71) Applicant: ALIBABA INNOVATION PRIVATE LIMITED, Singapore (SG)

(72) Inventors: Yuexiang XIE, Hangzhou (CN); Shaoyun SHI, Hangzhou (CN); Zhen WANG, Hangzhou (CN); Bolin DING, Bellevue, WA (US); Yaliang LI, Hangzhou (CN); Min ZHANG, Hangzhou (CN)

(21) Appl. No.: 18/853,069

(22) PCT Filed: Mar. 30, 2023
(86) PCT No.: PCT/CN2023/084940

§ 371 Date: Sep. 30, 2024

(30) Foreign Application Priority Data
Mar. 31, 2022 (CN) 202210346247.3

(51) Int. Cl. G06N 3/042; G06N 3/09

(52) U.S. Cl. CPC G06N 3/042; G06N 3/09

(57) ABSTRACT

The present disclosure provides a data processing method, apparatus and electronic device. The data processing method includes: acquiring (S201) attribute data of a target object, where the target object includes one of an image, a text, a voice or a user; inputting (S202) the attribute data into a prediction model for analysis to obtain a target prediction result corresponding to the attribute data and a target analysis basis for obtaining the target prediction result, where the prediction model includes a plurality of rule chains, each of which has a corresponding prediction result and an analysis basis, and the target prediction result is determined according to a prediction result corresponding to a target rule chain, and the target analysis basis is determined according to an analysis basis corresponding to the target rule chain, and the attribute data meets the analysis basis corresponding to the target rule chain.

### CROSS-REFERENCE TO RELATED APPLICATIONS

The present disclosure is a National Stage of International Application No. PCT/CN2023/084940, filed on Mar. 30, 2023, which claims the priority of Chinese Patent Application No. 202210346247.3 filed to China National Intellectual Property Administration on Mar. 31, 2022 and titled “Data processing method and apparatus, and electronic device”, the entire content of these applications are incorporated herein by reference.

### TECHNICAL FIELD

The present disclosure relates to the technical field of computers, in particular to a data processing method and apparatus, and an electronic device.

### BACKGROUND

At present, a neural network model has been widely used in academic research and industrial production, and achieved certain results. However, due to the black box characteristics of the neural network model, it is difficult for a user of the neural network model to understand and explain the knowledge learned by the neural network model from the data and the basis of an output result of the neural network model. Because of such problem, an application of the neural network model in industry is greatly limited, especially in the field that requires clear judgment criteria and transparent prediction process to ensure the reliability of the output result of the neural network model. For example, in the fields of medical care, finance and education, it is required for the neural network model in use to give the basis of the output result, but the current neural network model cannot give a corresponding basis.

### SUMMARY

Various aspects of the present disclosure provide a data processing method. apparatus and electronic device, which are configured to solve the problem that the current neural network model cannot give a basis of a corresponding output result.

An embodiment of the present disclosure provides a data processing method, which includes: acquiring attribute data of a target object, where the target object includes one of an image, a text, a voice or a user; inputting the attribute data into a prediction model for analysis to obtain a target prediction result corresponding to the attribute data and a target analysis basis for obtaining the target prediction result, where the prediction model includes a plurality of rule chains, each of which has a corresponding prediction result and an analysis basis, the target prediction result is determined according to a prediction result corresponding to a target rule chain, the target analysis basis is determined according to an analysis basis corresponding to the target rule chain, and the attribute data meets the analysis basis corresponding to the target rule chain.

An embodiment of the present disclosure also provides a data processing apparatus, including:
an acquiring module, configured to acquire attribute data of a target object, where the target object includes one of an image, a text, a voice or a user;
a processing module, configured to input the attribute data into a prediction model for analysis to obtain a target prediction result corresponding to the attribute data and a target analysis basis for obtaining the target prediction result, where the prediction model includes a plurality of rule chains, each of which has a corresponding prediction result and an analysis basis, and the target prediction result is determined according to a prediction result corresponding to a target rule chain, and the target analysis basis is determined according to an analysis basis corresponding to the target rule chain, and the attribute data meets the analysis basis corresponding to the target rule chain.

An embodiment of the present disclosure also provides an electronic device, which includes a memory and a processor; the memory is configured to store a program instruction; the processor is configured to call the program instruction in the memory to execute the data processing method as described above.

A data processing method provided by an embodiment of the present disclosure is applied to a scene where a model is adopted to predict a result and a basis for obtaining the corresponding result is needed, where the data processing method includes: acquiring attribute data of a target object, where the target object includes one of an image, a text, a voice or a user; inputting the attribute data into a prediction model for analysis to obtain a target prediction result corresponding to the attribute data and a target analysis basis for obtaining the target prediction result, where the prediction model includes a plurality of rule chains, each of which has a corresponding prediction result and an analysis basis, and the target prediction result is determined according to a prediction result corresponding to a target rule chain, and the target analysis basis is determined according to an analysis basis corresponding to the target rule chain, and the attribute data meets the analysis basis corresponding to the target rule chain. In an embodiment of the present disclosure, since the prediction model includes a plurality of rule chains, each rule chain has a corresponding prediction result and an analysis basis, when the attribute data meets the analysis basis corresponding to the target rule chain, the target prediction result can be determined and the corresponding target analysis basis for obtaining the target prediction result can be determined at the same time.

### BRIEF DESCRIPTION OF DRAWINGS

The accompanying drawings described here are provided to provide a further understanding of the present disclosure and constitute a part of the present disclosure. The schematic embodiments of the present disclosure and their descriptions are used to explain the present disclosure and do not constitute an undue limitation on the present disclosure. In the accompanying drawings:

FIG. 1 is a schematic diagram of a data processing method provided by an exemplary embodiment of the present disclosure.

FIG. 2 is a step flowchart of a data processing method provided by an exemplary embodiment of the present disclosure.

FIG. 3 is a structural block diagram of a prediction model provided by an exemplary embodiment of the present disclosure.

FIG. 4 is a structural block diagram of another prediction model provided by an exemplary embodiment of the present disclosure.

FIG. 5 is a structural block diagram of yet another prediction model provided by an exemplary embodiment of the present disclosure.

FIG. 6 is a step flowchart of another data processing method provided by an exemplary embodiment of the present disclosure.

FIG. 7 is a structural block diagram of a processing node provided by an exemplary embodiment of the present disclosure.

FIG. 8 is a step flowchart of a training method of a prediction model provided by an exemplary embodiment of the present disclosure.

FIG. 9 is a structural block diagram of a data processing apparatus provided by an exemplary embodiment of the present disclosure.

FIG. 10 is a schematic structural diagram of an electronic device provided by an exemplary embodiment of the present disclosure.

### DESCRIPTION OF EMBODIMENTS

In order to make the purpose, technical solution and advantage of the present disclosure more clear, the technical solution of the present disclosure will be described clearly and completely with specific embodiments of the present disclosure and the corresponding drawing. It is evident that the embodiment in the following description are some embodiments of the present disclosure, not all of the embodiments. For those of ordinary skill in the art, other embodiments obtained based on the embodiments of the present disclosure without creative effort fall into the protection scope of the present disclosure.

For the problem that, in the fields of medical care, finance and education, it is required for the neural network model in use to give the basis of the output result, but the current neural network model cannot give a corresponding basis, the embodiment of the present disclosure implements by acquiring attribute data of a target object, which includes one of an image, a text, a voice or a user; inputting the attribute data into a prediction model for analysis, and obtaining a target prediction result corresponding to the attribute data and a target analysis basis for obtaining the target prediction result, where the prediction model includes a plurality of rule chains, each of which has a corresponding prediction result and an analysis basis, and the target prediction result is determined according to a prediction result corresponding to a target rule chain, and the target analysis basis is determined according to an analysis basis corresponding to the target rule chain, and the attribute data meets the analysis basis corresponding to the target rule chain. In an embodiment of the present disclosure, the prediction model includes a plurality of rule chains, each rule chain has a corresponding prediction result and an analysis basis; when the attribute data meets the analysis basis corresponding to the target rule chain, the target prediction result can be determined and the corresponding target analysis basis for obtaining the target prediction result can be determined at the same time.

In this embodiment, the execution device of the data processing method is not limited. In an implementation, the whole data processing method can be implemented by means of a cloud computing system. For example, the data processing method can be applied to a cloud server in order to run various prediction models with the advantage of resources on the cloud. Compared with the application in the cloud, the data processing method can also be applied to a server device such as a conventional server, a cloud server or a server array.

In addition, the data processing method provided by the embodiment of the present disclosure can be applied to the medical industry. For example, if the target object is a human (user), the attribute data of the target object includes data such as age, gender, weight, height, blood pressure, blood sugar, blood lipid, etc. These data are input into the prediction model to predict the diseases of the target object. If the corresponding target prediction result is “cerebral infarction”, it is necessary to give the target analysis basis for obtaining the target prediction result of “cerebral infarction”. such as age over 60, weight over 80 kg and blood lipid over 2.3 mmol/L. In addition, the data processing method provided by the embodiment of the present disclosure can be applied to the appraisal industry. For example, the target object is a plurality of segmented images, and the attribute data of the images include: resolution, depth, RGB value and the like of the images. The attribute data of the plurality of segmented images are input into the prediction model to predict the target prediction result (the whole image spliced by the plurality of segmented images), it is necessary to provide the target analysis basis for obtaining the target prediction result of “whole image”, such as the first image is on the upper side of the second image, and the second image is on the left side of the third image. Furthermore, the data processing method provided by the embodiment of the present disclosure can be applied to the financial industry, for example, the target object is a text, and the text represents a corresponding fund logo, and the attribute data corresponding to the fund logo includes the corresponding investment content of the fund, the investment period of the fund, the investment income of the fund at different historical times, and the historical investment environment of the fund. The attribute data are input into the prediction model to predict the target prediction result (the investment income in the next year will be better), so it is necessary to give the target analysis basis for obtaining this target prediction result. For example, the investment income of the fund is good and stable under the unstable historical investment environment. In an embodiment of the present disclosure, the prediction model can be applied in any scene where the target analysis basis of the target prediction result needs to be given, which is not listed here.

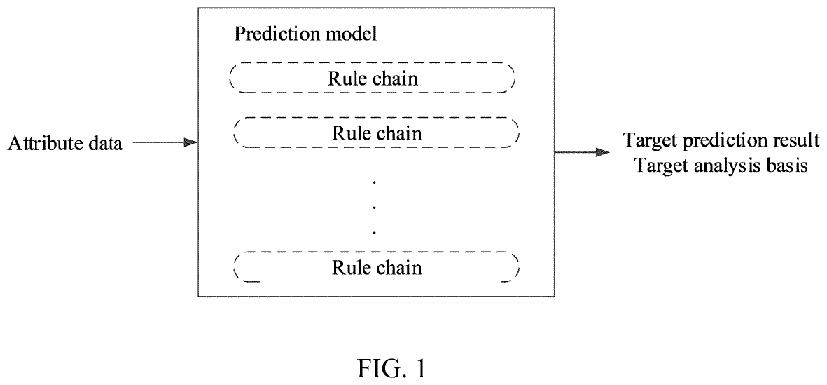

For example, referring to FIG. 1, a prediction model includes a plurality of rule chains, and each rule chain has a corresponding prediction result and an analysis basis. Attribute data of a target object is input into the prediction model for analysis to obtain a target prediction result corresponding to the attribute data and a target analysis basis for obtaining the target prediction result. When the attribute data meets the analysis basis corresponding to the target rule chain, the prediction result corresponding to the target rule chain is determined to be the target prediction result.

In the following, the technical solution provided by each embodiment of the present disclosure will be described in detail with the accompanying drawings.

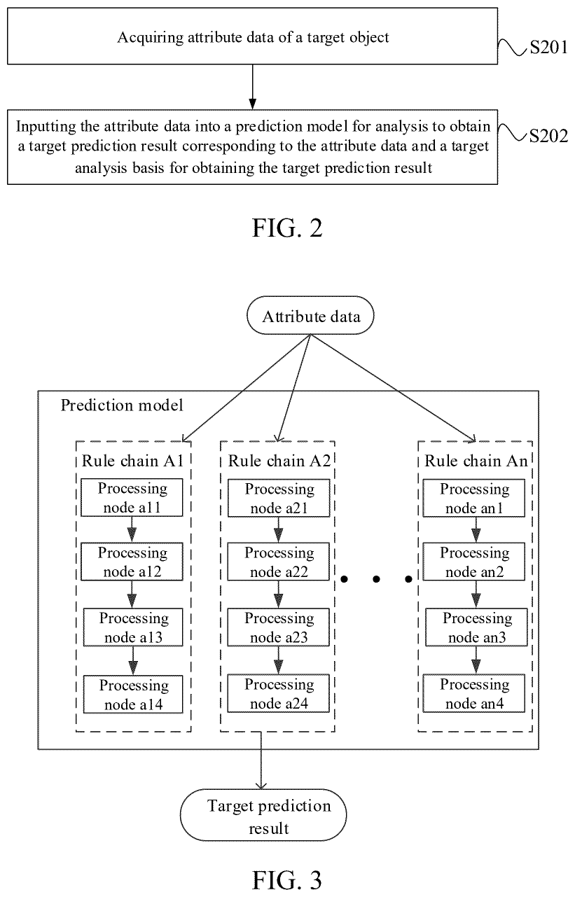

FIG. 2 is a step flowchart of a data processing method provided by an exemplary embodiment of the present disclosure. As shown in FIG. 2, the data processing method specifically includes the following steps:

S201, acquiring attribute data of a target object.

The target object includes one of an image, a text, a voice or a user.

In an embodiment of the present disclosure, the target object can be any object. For example, when the target object is a user, the attribute data of the target object includes: age, gender, work, education, physical state, etc. When the target object is a voice, the attribute data of the target object can be pitch, sound intensity, sound length and sound quality.

S202, inputting the attribute data into a prediction model for analysis to obtain a target prediction result corresponding to the attribute data and a target analysis basis for obtaining the target prediction result.

The prediction model includes a plurality of rule chains, each rule chain has a corresponding prediction result and an analysis basis, the target prediction result is determined according to a prediction result corresponding to a target rule chain, the target analysis basis is determined according to an analysis basis corresponding to the target rule chain, and the attribute data meets the analysis basis corresponding to the target rule chain.

For example, referring to FIG. 3, it is a prediction model, which includes a plurality of rule chains, such as rule chain A1, rule chain A2 to rule chain An. Respective rule chains in FIG. 3 are in a parallel structure.

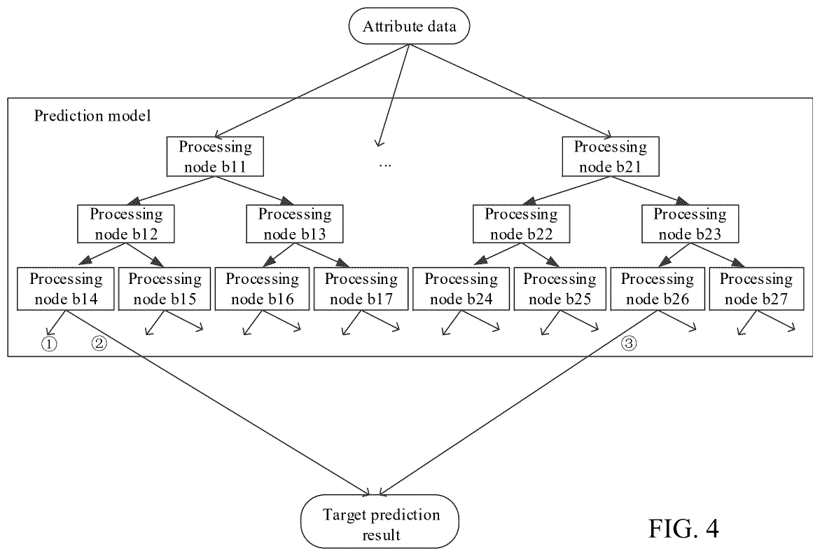

Referring to FIG. 4, it is another prediction model, and the rule chain of the prediction model is a tree structure, such as processing node b11, processing node b12 and processing node b14 form a rule chain; processing node b11, processing node b12 and processing node b15 form a rule chain; processing node b11, processing node b13 and processing node b16 form a rule chain; processing node b11, processing node b13 and processing node b17 form a rule chain; processing node b21, processing node b22 and processing node b24 form a rule chain; processing node b21, processing node b22 and processing node b25 form a rule chain; processing node b21, processing node b23 and processing node b26 form a rule chain; processing node b21, processing node b23 and processing node b27 form a rule chain. It can be concluded that when the prediction model has k tree structures and the depth of the tree structure is h, there are a total of rule chains k×2^{h-1}.

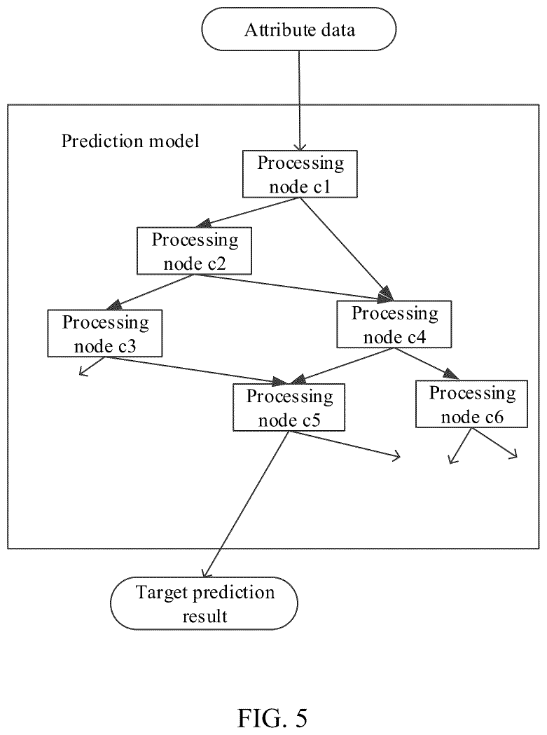

Referring to FIG. 5, it is another prediction model, and the rule chain of the prediction model is a graphic structure, such as processing node c1, processing node c2 and processing node c3 are a rule chain. Processing node c1, processing node c2. processing node c3 and processing node c5 are a rule chain. Processing node c1, processing node c2, processing node c4 and processing node c5 are a rule chain. Processing node cl, processing node c2, processing node c4 and processing node c6 are a rule chain. Processing node c1, processing node c4 and processing node c5 are a rule chain. Processing node c1, processing node c4 and processing node c6 are a rule chain.

In an embodiment of the present disclosure, the rule chains can be in various structural forms, where each rule chain has a corresponding prediction result and an analysis basis, and when the attribute data meets the analysis basis of the corresponding rule chain, the prediction result of the rule chain is taken as the target prediction result.

For example, referring to FIG. 3, the salary of a user is predicted, where if the attribute data of user A is: age 30, gender female, working as an automobile engineer, living in Beijing, with a master's degree, and if the analysis basis corresponding to rule chain A1 is that the age is between 30 and 35, working as a software engineer, living in Beijing, Shanghai, Guangzhou or Shenzhen, with an undergraduate degree, the corresponding prediction result is annual salary of 400,000 to 500,000. The attribute data of user A does not meet the analysis basis of rule chain A1. If the corresponding analysis basis of rule chain A2 is that the age is between 25 and 30 (including 30), working as an automobile engineer or mechanical engineer, with a master's degree, and the gender is female, and the corresponding prediction result is annual salary of 200,000 to 300,000. Then the attribute data of user A meets the analysis basis corresponding to rule chain A2, and the target prediction result output by the prediction model is 200,000-300,000 annual salary. The attribute data of user A meets the analysis basis corresponding to rule chain A2, and the target prediction result output by the prediction model is annual salary of 200,000 to 300,000. The target prediction basis is that under the conditions that user A is between 25 and 30 years old, works as an automobile engineer or mechanical engineer, has a master's degree and is female, the annual salary is estimated to be between 200,000 and 300,000.

In an embodiment of the present disclosure, when the prediction model is a graphic structure or a tree structure, each rule chain corresponds to two analysis bases and a prediction result corresponding to each of the two analysis bases. For example, in FIG. 4, for a rule chain formed by processing node b11, processing node b12 and processing node b14, the analysis basis of the rule chain is that if the attribute data of user A meets the logic of processing node b11, processing node b12 and processing node b14, the target prediction result corresponding to the attribute data of user A is the prediction result \textcircled{1} corresponding to the rule chain. If the attribute data of user A meets the logic of processing node b11 and processing node b12, but does not meet the logic of processing node b14, the target prediction result corresponding to the attribute data of user A is the prediction result \textcircled{2} corresponding to the rule chain. If the processing node is met, it will enter the sub-node (processing node) on the left side of the processing node; if not, it will enter the sub-node (processing node) on the right side of the processing node.

The data processing method provided by the embodiment of the present disclosure is applied to a scene where a model is used to predict the result and a basis for obtaining the corresponding result is needed, where the data processing method includes: acquiring attribute data of a target object, where the target object includes one of an image, a text, a voice or a user; inputting the attribute data into a prediction model for analysis to obtain a target prediction result corresponding to the attribute data and a target analysis basis for obtaining the target prediction result, where the prediction model includes a plurality of rule chains, each of which has a corresponding prediction result and an analysis basis, and the target prediction result is determined according to a prediction result corresponding to a target rule chain, and the target analysis basis is determined according to an analysis basis corresponding to the target rule chain, and the attribute data meets the analysis basis corresponding to the target rule chain. In an embodiment of the present disclosure, since the prediction model includes a plurality of rule chains, each rule chain has a corresponding prediction result and an analysis basis, when the attribute data meets the analysis basis corresponding to the target rule chain, the target prediction result can be determined and the corresponding target analysis basis for obtaining the target prediction result can be determined at the same time.

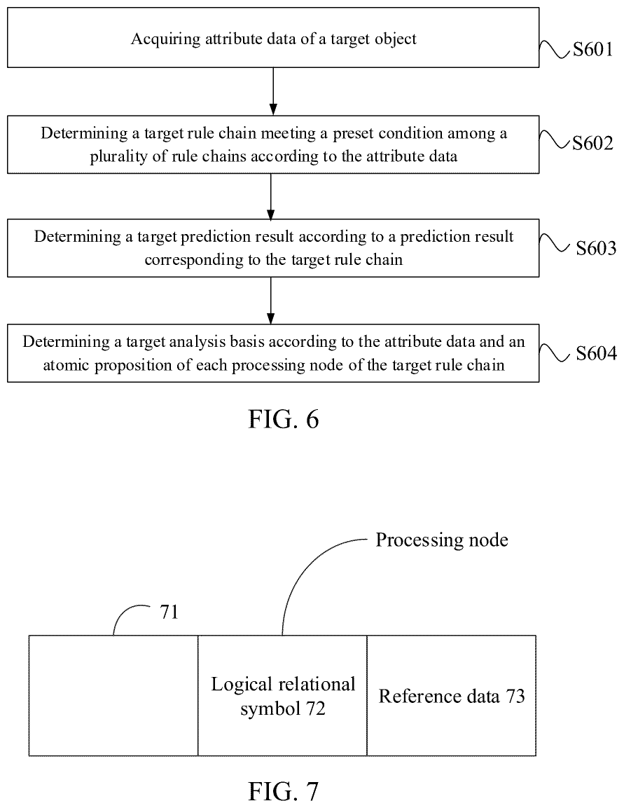

In an embodiment of the present disclosure, another data processing method is provided, as shown in FIG. 6, which specifically includes the following steps:

S601, acquiring attribute data of a target object.

S602, determining a target rule chain meeting a preset condition among a plurality of rule chains according to the attribute data.

The rule chain includes a plurality of processing nodes connected in series, each processing node correspondingly represents an atomic proposition, and the preset condition is that a prediction result corresponding to the target rule chain can be obtained after the attribute data are inputted into the target rule chain for data processing.

Specifically, referring to FIG. 3 to FIG. 5, each rule chain includes a plurality of processing nodes connected in series, where the atomic proposition refers to a simple proposition that can't be decomposed into other propositions in structure. For example, in FIG. 3, the atomic proposition corresponding to processing node a11 is that the age is between 30 and 35.

The processing node includes a logical relational symbol and reference data. and the plurality of rule chains are in a parallel structure, and S602 includes: inputting the attribute data into a processing node for data processing to obtain an output result; if the output result indicates that a target logical relationship between the attribute data and the reference data is the same as a reference logical relationship, the processing node is determined as a target processing node, and the reference logical relationship is a logical relationship indicated by a logical relational symbol; the target rule chain is determined according to the target processing node, and all processing nodes in the target rule chain are target processing nodes.

Specifically, the logical relational symbol includes a symbol corresponding to a logical relationship such as greater than, less than, equal to, greater than or equal to, less than or equal to, and belonging. Referring to FIG. 3, a plurality of rule chains of the prediction model shown are in a parallel structure. Referring to FIG. 7, it is a schematic structural diagram of the processing result, a blank area 71 of the processing node is configured to input attribute data and it is determined whether the attribute data and the reference data 73 meet the reference logical relationship of the Logical relational symbol 72. For example, if the attribute data of user A is: age 30, gender female, working as an automobile engineer, living in Beijing, and having a master's degree. The logical relational symbol of processing node a11 of rule chain A1 is “∈” (indicating belonging), and the reference data is (30,35] (indicating between 30 and 35); the logical relational symbol of processing node a12 is “=” (indicating yes), and the reference data is “software engineer”; the logical relational symbol of processing node a13 is “∈” (indicating belonging), the reference data is “Beijing, Shanghai, Guangzhou or Shenzhen”, the logical relational symbol of processing node a14 is “=” (indicating yes), and the reference data is “undergraduate”. The target logical relationship between the attribute data of user A and the reference data of processing node a11 does not conform to the reference logical relationship, that is, the age of user A does not belong to (30,35], so processing node a11 is not a target processing node. In the same way, it is determined that processing node a12 is not a target processing node, processing node a13 is a target processing node, and processing node a14 is not a target processing node, so it is determined that not a11 processing nodes in rule chain A1 are target processing nodes, so rule chain A1 is not the target rule chain. In an actual operation process, when the attribute data does not meet processing node a11, processing node a12, processing node a13 and processing node a14 will not be operated.

In the same way as above, the logical relational symbol of processing node a21 in rule chain A2 is “∈” (indicating belonging), and the reference data is (25,30] (indicating between 25 and 30); the logical relational symbol of processing node a22 is “∈” (indicating belonging), and the reference data is “automobile engineer or mechanical engineer”; the logical relational symbol of processing node a23 is “=” (indicating yes), and the reference data is “Master”; the logical relational symbol of processing node a23 is “=” (indicating yes), and the reference data is “female”; It can be determined that processing node a21, processing node a22, processing node a23 and processing node a24 are all target processing nodes, and rule chain A2 is the target rule chain.

In an embodiment of the present disclosure, both the logical relational symbol and the reference data are obtained by training the prediction model in advance. In addition, the number of rule chains, the number of processing nodes on the rule chain and the connection relationship of processing nodes of the prediction model are all pre-trained.

In an alternative embodiment, the plurality of rule chains are in a graphic structure or a tree structure, and the processing node in the graphic structure or the tree structure is a first processing node, an intermediate processing node or a tail processing node. An output end of the first processing node and an output end of the intermediate processing node both are connected with two processing nodes, and an input end of the intermediate processing node and an input end of the tail processing node both are connected with one processing node, and the target rule chain includes a first processing node, a target intermediate processing node and a target tail processing node. The determining a target rule chain meeting a preset condition among a plurality of rule chains according to the attribute data includes: inputting the attribute data into a processing node for data processing to obtain an output result; determining a target intermediate processing node according to an output result of the first processing node, where when the output result of the first processing node indicates that the target logical relationship and the reference logical relationship are the same, one intermediate processing node connected with the first processing node serves as the target intermediate processing node, and when the output result of the first processing node indicates that the target logical relationship and the reference logical relationship are different, another intermediate processing node connected with the first processing node serves as the target intermediate processing node; determining the target tail processing node according to the output result of the target intermediate processing node.

In FIG. 4, a first processing node is a root node of a tree, such as processing node b11 and processing node b21, where the attribute data is input to one or more first processing nodes. The intermediate processing node could be such as processing node b12, processing node b13, processing node b22 and processing node b23. The tail processing node could be such as processing node b14, processing node b15, processing node b17, processing node b24, processing node b25, processing node b26 and processing node b27. If the rule chain formed by processing node b11, processing node b12 and processing node b14 is the target rule chain, processing node b12 is the target intermediate processing node and processing node 14 is the target tail processing node.

For example, if the attribute data of user A is: age 30, gender female, working as an automobile engineer, living in Beijing, with a master's degree. The logical relational symbol of processing node b11 is “≤” (indicating less than or equal to), and the reference data is “35”; the logical relational symbol of processing node b12 is “∈”, and the reference data is “automobile engineer or mechanical engineer”; the logical relational symbol of processing node b14 is “=” (indicating yes), and the reference data is “undergraduate”. The target logical relationship between the attribute data of user A and the reference data of processing node b11 conforms to the reference logical relationship, that is, if the age of user A is less than 35, processing node b12 is the target intermediate processing node, and processing node b14 is determined to be the target tail processing node in the same way.

In addition, the processing logic of the attribute data in the prediction model shown in FIG. 5 is the same as that in the prediction model shown in FIG. 4, and the details are not repeated here.

Further, a logical relational symbol is simulated by a preset neural network, and the inputting the attribute data into a processing node for data processing to obtain an output result includes: inputting the attribute data and a reference data into a preset neural network for data processing to output a target logical relationship; determining the output result according to the target logical relationship and a reference logical relationship corresponding to the logical relational symbol.

In an embodiment of the present disclosure, each logical relational symbol corresponds to a preset neural network, which is pre-trained and can predict a target logical relationship between attribute data and reference data. For example, for a logical relational symbol “∈”, attribute data and reference data are input into a preset neural network corresponding to the logical relational symbol, and an output target logical relationship is whether it belongs or not. For a logical relational symbol “=”, attribute data and reference data are input into a preset neural network corresponding to the logical relational symbol, and an output target logical relationship is yes or no.

Further, the preset neural network includes: RNN (a cyclic neural network), CNN (convolutional neural network) and so on.

S603, determining a target prediction result according to a prediction result corresponding to the target rule chain.

In an embodiment of the present disclosure, for a prediction model in a parallel structure, as shown in FIG. 3, each rule chain corresponds to a prediction result, and a target prediction result can be obtained by calculating the weight of prediction results of different target rule chains. For a prediction model in a graphic structure or a tree structure, as shown in FIG. 4 and FIG. 5, each rule chain has two prediction results, and one prediction result corresponding to the target rule chain is determined according to whether the attribute data meets the reference logical relationship of the target tail processing node on the target rule chain. For example, when the attribute data does not meet the reference logical relationship of processing node b14, a prediction result \textcircled{2} is output. If the attribute data meets the reference logical relationship of processing node b14, another prediction result \textcircled{1} is output. Similarly, the rule chain formed by processing node b21, processing node b23 and processing node b26 in FIG. 4 is the target rule chain, and the attribute data meets the reference logical relationships corresponding to processing node b21, processing node b23, and processing node b26, then a corresponding prediction result \textcircled{3} is output. In an embodiment of the present disclosure, output prediction results corresponding to different target rule chains can be calculated according to a weight parameter obtained by pre-training to obtain a target prediction result.

In an embodiment of the present disclosure, the attribute data will meet analysis bases of one or more rule chains. When the analysis basis of only one rule chain is met, the analysis basis of this rule chain is taken as a target analysis basis; if analysis bases of multiple rule chains are met, the union of the analysis bases of multiple rule chains is taken a target analysis basis. For example, if an analysis basis of one rule chain met by a user's attribute data is age greater than 20 and an analysis basis of another rule chain met by the user's attribute data is age greater than 25, a target analysis basis is determined to be age greater than 25.

Further, for a prediction model in a tree structure, attribute data will be simultaneously input to top processing node(s) of one or more trees (such as processing node b11 and processing node b21 in FIG. 4). When the attribute data meets the atomic proposition of processing node b11, the attribute data will be transferred to the left (to processing node b12), and if not, the attribute data will be transferred to the right (to b13) until the attribute data is transferred to a leaf node of the tree (such as processing node b14).

S604, determining a target analysis basis according to the attribute data and an atomic proposition of each processing node of the target rule chain.

The determining a target analysis basis according to the attribute data and an atomic proposition of each processing node of the target rule chain includes: determining the target analysis basis according to the attribute data, target logical relationship and reference data corresponding to a target processing node.

For example, in FIG. 4, the attribute data are age 30, gender female, working as an automobile engineer, living in Beijing, and having a master's degree. The target logical relationship corresponding to processing node b11 is “less than or equal to” and the reference data is “35”; the target logical relationship corresponding to processing node b12 is “belonging” and the reference data is “automobile engineer or mechanical engineer”; the target logical relationship of processing node b14 is “No” and the reference data is “undergraduate”. Then the target analysis basis is determined as user A is younger than 35, belongs to an automobile engineer, and is not an undergraduate.

In an embodiment of the present disclosure, a preset neural network is configured to simulate a logical relational symbol, and a rule chain is constructed to generate a prediction model, so that an accurate prediction result can be obtained and an analysis basis of the corresponding prediction result can be given at the same time, thus a user can understand the knowledge learned in the training process of the prediction model, the interpretability of the prediction model is realized, and the application field of the model is expanded. Furthermore, the obtained target analysis basis can provide support for a researcher to adjust the prediction model, and then provide the generalization ability of the prediction model.

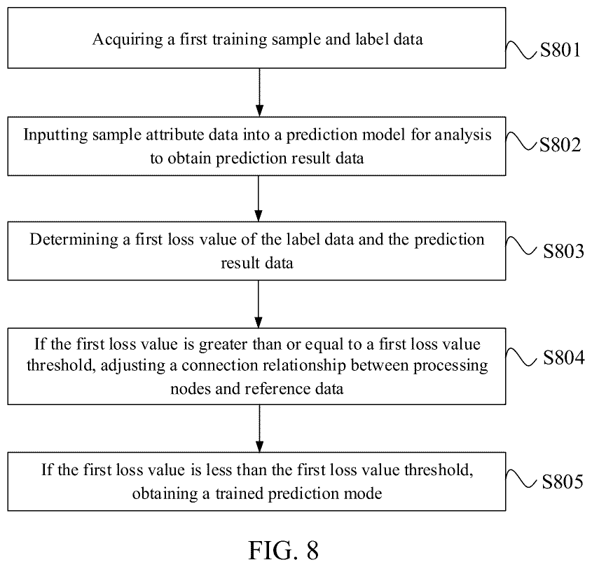

In an embodiment of the present disclosure, a training method of a prediction model is provided, as shown in FIG. 8, and the training method of the prediction model specifically includes the following steps:

S801, acquiring a first training sample and label data.

The first training sample includes sample attribute data of a sample object, and a sample label indicates a category or a potential characteristic of the sample object. If the sample object is a user, the category of a user is such as good student, poor student, big customer, medium customer and small customer. The potential characteristic is such as salary situation of the user, possible physical illness of the user, etc.

In an embodiment of the present disclosure, the first training sample and the label data can be determined according to an application scenario and a purpose of the training model. The first training sample can be one of an image, a text or a voice.

For example, if the first training sample is: 30 years old, gender female, working as an automobile engineer, living in Beijing, with a master's degree. The label data is the annual salary of 280,000.

S802, inputting sample attribute data into a prediction model for analysis to obtain prediction result data.

The prediction model includes a rule chain, and the rule chain includes a plurality of processing nodes connected in series, and each processing node includes a logical relational symbol and reference data, and the logical relational symbol is obtained by a simulation of a corresponding preset neural network.

Specifically, the number of processing nodes of each rule chain, as well as each logical relational symbol and reference data can be obtained by training.

The method for training the logical relational symbol includes: acquiring a second training sample and a third training sample, where the second training sample and the third training sample have a reference logical relationship; processing the second training sample and the third training sample with a preset neural network to obtain a predicted logical relationship; determining a second loss value corresponding to the reference logical relationship and the predicted logical relationship; if a second loss value is greater than or equal to a second loss value threshold, adjusting a network parameter of the preset neural network; if the second loss value is less than the second loss value threshold, the trained preset neural network is obtained, and the trained preset neural network is configured to simulate the logical relational symbol.

If the logical relational symbol is a greater-than sign, the second training sample is greater than the third training sample, and then the second training sample being greater than the third training sample is adopted to train the preset neural network, and the preset neural network finally obtained by training can simulate the greater-than sign. Similarly, the preset neural network can be trained to simulate a logical relational symbol such as an equality and belonging, etc.

S803, determining a first loss value of the label data and the prediction result data.

S804, if the first loss value is greater than or equal to a first loss value threshold, adjusting a connection relationship between processing nodes and reference data.

S805, if the first loss value is less than the first loss value threshold, obtaining a trained prediction model.

Illustratively, a prediction model of an embodiment of the present disclosure has an initial processing node, each processing node has an initial reference logic relational symbol and reference data, and there is an initial connection relationship between processing nodes. In the training process, a parameter such as the connection relationship between processing nodes and the reference data can be adjusted by the first loss value, and finally the adjusted prediction model has generalization ability and robustness.

In an embodiment of the present disclosure, after the logical relational symbol is obtained by training, a staff can select a logical relational symbol and reference data to form a processing node according to his/her experience, and then construct a prediction model of the present disclosure according to the formed processing node. An effective processing node can also be automatically selected to form a prediction model by training with the first training sample.

In an embodiment of the present disclosure, a prediction model with strong expressive ability can be obtained by training a logical relational symbol and a prediction model, and the prediction model can output an accurate prediction result and a corresponding analysis basis.

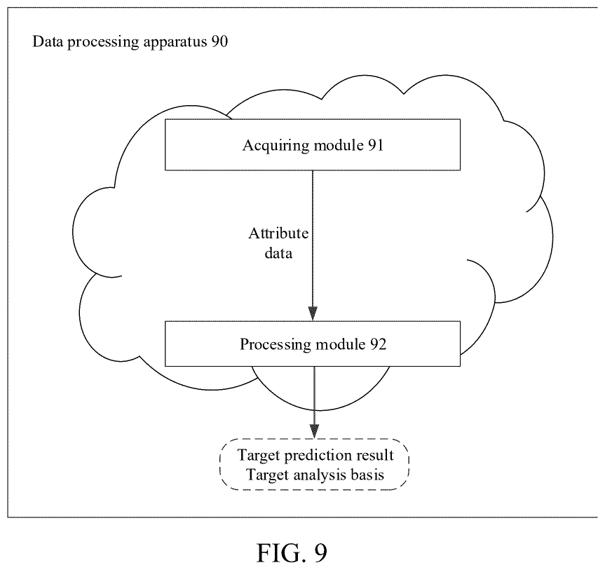

In an embodiment of the present disclosure, in addition to providing a data processing method, a data processing apparatus is also provided. As shown in FIG. 9, the data processing apparatus 90 includes:
an acquiring module 91, configured to acquire attribute data of a target object, where the target object includes one of an image, a text, a voice or a user;
a processing module 92, configured to input the attribute data into a prediction model for analysis to obtain a target prediction result corresponding to the attribute data and a target analysis basis for obtaining the target prediction result, where the prediction model includes a plurality of rule chains, each of which has a corresponding prediction result and an analysis basis, and the target prediction result is determined according to a prediction result corresponding to a target rule chain, and the target analysis basis is determined according to an analysis basis corresponding to the target rule chain, and the attribute data meet the analysis basis corresponding to the target rule chain.

In an alternative embodiment, the rule chain includes a plurality of processing nodes connected in series, each processing node correspondingly represents an atomic proposition, and the processing module 92 is specifically configured to: determine a target rule chain meeting a preset condition among a plurality of rule chains according to attribute data, and the preset condition is that a prediction result corresponding to the target rule chain can be obtained after the attribute data are inputted into the target rule chain for data processing; determine a target prediction result according to the prediction result corresponding to the target rule chain; determine a target analysis basis according to the attribute data and an atomic proposition of each processing node of the target rule chain.

In an alternative embodiment, the processing node includes a logical relational symbol and reference data, and a plurality of rule chains are in a parallel structure. When the processing module 92 determines a target rule chain meeting a preset condition among a plurality of rule chains according to attribute data, the processing module 92 is specifically configured to input the attribute data to a processing node for data processing to obtain an output result; if the output result indicates that a target logical relationship between the attribute data and the reference data is the same as a reference logical relationship, determine the processing node as a target processing node, and the reference logical relationship is a logical relationship indicated by the logical relational symbol; according to the target processing node, determine the target rule chain, and all processing nodes on the target rule chain are target processing nodes.

In an alternative embodiment, a plurality of rule chains are in a graphic structure or a tree structure, and a processing node in the graphic structure or the tree structure is a first processing node, an intermediate processing node or a tail processing node. An output end of the first processing node and an output end of the intermediate processing node both are connected with two processing nodes, and an input end of the intermediate processing node and an input end of the tail processing node both are connected with one processing node, and a target rule chain includes a first processing node, a target intermediate processing node and a target tail processing node. When the processing module 92 determines a target rule chain meeting a preset condition among a plurality of rule chains according to attribute data, the processing module 92 is specifically configured to input the attribute data into a processing node for data processing to obtain an output result; determine a target intermediate processing node according to an output result of the first processing node, where when the output result of the first processing node indicates that a target logical relationship and a reference logical relationship are the same, one intermediate processing node connected with the first processing node serves as the target intermediate processing node, and when the output result of the first processing node indicates that a target logical relationship and a reference logical relationship are different, another intermediate processing node connected with the first processing node serves as the target intermediate processing node; determine the target tail processing node according to the output result of the target intermediate processing node.

In an alternative embodiment, a logical relational symbol is simulated by a preset neural network, and when the processing module 92 inputs attribute data into a processing node for data processing to obtain an output result, the processing module 92 is specifically configured to input the attribute data and reference data into the preset neural network for data processing, so as to output a target logical relation; determine an output result according to a target logical relationship and a reference logical relationship corresponding to the logical relational symbol.

In an alternative embodiment, when the processing module 92 determines a target analysis basis according to attribute data and an atomic proposition of each processing node of a target rule chain, the processing module 92 is specifically configured to determine the target analysis basis according to the attribute data, a target logical relationship and reference data corresponding to a target processing node.

In an alternative embodiment, the data processing apparatus 90 further includes a training module (not shown) configured to acquire a first training sample and label data, where the first training sample includes sample attribute data of a sample object, and a sample label indicates a category or a potential characteristic of the sample object; input the sample attribute data into a prediction model for analysis to obtain prediction result data, where the prediction model includes a rule chain, and the rule chain includes a plurality of processing nodes connected in series, each processing node includes a logical relational symbol and reference data, and the logical relational symbol is obtained by a simulation of a corresponding preset neural network; determine a first loss value of the label data and the prediction result data; if the first loss value is greater than or equal to a first loss value threshold, adjust a connection relationship between processing nodes and the reference data; if the first loss value is less than the first loss value threshold, obtain a trained prediction model.

In an alternative embodiment, the training module is further configured to obtain a second training sample and a third training sample, where the second training sample and the third training sample have a reference logical relationship; process the second training sample and the third training sample by adopting a preset neural network to obtain a predicted logical relationship; determine a second loss value corresponding to the reference logical relationship and the predicted logical relationship; if the second loss value is greater than or equal to a second loss value threshold, adjust a network parameter of the preset neural network; if the second loss value is less than the second loss value threshold, obtain a trained preset neural network, and the trained preset neural network is configured to simulate a logical relational symbol.

For a data processing apparatus provided by an embodiment of the present disclosure, since a prediction model includes a plurality of rule chains, each rule chain has a corresponding prediction result and an analysis basis, when attribute data meets an analysis basis corresponding to a target rule chain, a target prediction result can be determined and a corresponding target analysis basis for obtaining the target prediction result can be determined at the same time.

In addition, some processes described in the above embodiments and the accompanying drawings contain a plurality of operations that present in a specific order, but it should be clearly understood that these operations may be executed out of the order in which they present herein or may be executed in parallel, and a serial number is only used to distinguish different operations, and the serial number itself does not represent any execution order. In addition, these processes may include more or fewer operations, and these operations may be performed sequentially or in parallel. It should be noted that the descriptions of “first” and “second” in this specification are used to distinguish different messages, devices, modules, etc., and do not represent the sequence, nor do they limit that “first” and “second” are different types.

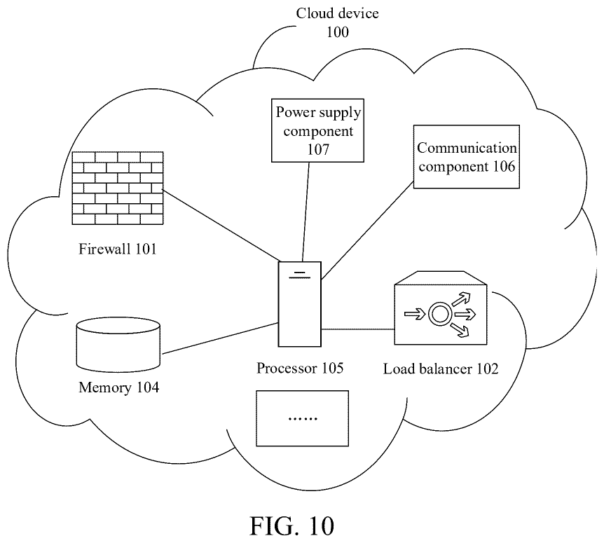

FIG. 10 is a schematic structural diagram of an electronic device provided by an exemplary embodiment of the present disclosure. The electronic device is configured to run the mentioned data processing method. As shown in FIG. 10, the electronic device includes a memory 104 and a processor 105.

The memory 104 is configured to store a computer program and can be configured to store various other data to support operations on the electronic device. The memory 104 may be an object storage service (OSS).

The memory 104 can be implemented by any type of volatile or nonvolatile memory device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

A processor 105, coupled with the memory 104, is configured to execute a computer program in the memory 104, so as to acquire attribute data of a target object. which includes one of an image, a text, a voice or a user; input the attribute data into a prediction model for analysis to obtain a target prediction result corresponding to the attribute data and a target analysis basis for obtaining the target prediction result, where the prediction model includes a plurality of rule chains, each of which has a corresponding prediction result and an analysis basis, and the target prediction result is determined according to a prediction result corresponding to a target rule chain, and the target analysis basis is determined according to an analysis basis corresponding to the target rule chain, and the attribute data meets the analysis basis corresponding to the target rule chain.

In an further implementation, when the processor 105 inputs the attribute data into a prediction model for analysis to obtain a target prediction result corresponding to the attribute data and a target analysis basis for obtaining the target prediction result, the processor 105 is specifically configured to: determine a target rule chain meeting a preset condition among a plurality of rule chains according to the attribute data, and the preset condition is that a prediction result corresponding to the target rule chain can be obtained after the attribute data are inputted into the target rule chain for data processing; determine the target prediction result according to the prediction result corresponding to the target rule chain; determine the target analysis basis according to the attribute data and an atomic proposition of each processing node of the target rule chain.

In an alternative embodiment, when the processor 105 determines a target rule chain meeting a preset condition among a plurality of rule chains according to the attribute data, the processor 105 is specifically configured to: input the attribute data to a processing node for data processing to obtain an output result; if the output result indicates that a target logical relationship between the attribute data and reference data is the same as a reference logical relationship. determine the processing node as a target processing node, and the reference logical relationship is a logical relationship indicated by a logical relational symbol; determine a target rule chain according to the target processing node, and all processing nodes on the target rule chain are target processing nodes.

In an alternative embodiment, when the processor 105 determines a target rule chain meeting a preset conditions among a plurality of rule chains according to the attribute data, the processor 105 is specifically configured to: input the attribute data to a processing node for data processing to obtain an output result; determine a target intermediate processing node according to an output result of a first processing node, where when the output result of the first processing node indicates that a target logical relationship and a reference logical relationship are the same, one intermediate processing node connected with the first processing node serves as the target intermediate processing node, and when the output result of the first processing node indicates that the target logical relationship and the reference logical relationship are different, another intermediate processing node connected with the first processing node serves as the target intermediate processing node; determine a target tail processing node according to the output result of the target intermediate processing node.

In an alternative embodiment, when the processor 105 inputs the attribute data into a processing node for data processing to obtain an output result, the processor 105 is specifically configured to input the attribute data and reference data into a preset neural network for data processing to output a target logical relationship; determine the output result according to the target logical relationship and a reference logical relationship corresponding to a logical relational symbol.

In an alternative embodiment, the processor 105 determines the target analysis basis according to the attribute data and an atomic proposition of each processing node of the target rule chain, the processor 105 is specifically configured to determine the target analysis basis according to the attribute data, a target logical relationship and reference data corresponding to the target processing node.

In an alternative embodiment, the processor 105 is further configured to acquire a first training sample and label data, where the first training sample includes sample attribute data of a sample object, and a sample label indicates a category or a potential characteristic of the sample object; input the sample attribute data into a prediction model for analysis to obtain prediction result data, where the prediction model includes a rule chain, and the rule chain includes a plurality of processing nodes connected in series, each processing node includes a logical relational symbol and reference data, and the logical relational symbol is obtained by a simulation of a corresponding preset neural network; determine a first loss value of the label data and the prediction result data; if the first loss value is greater than or equal to a first loss value threshold, adjust a connection relationship between processing nodes and the reference data; if the first loss value is less than the first loss value threshold, obtain a trained prediction model.

In an alternative embodiment, the processor 105 is further configured to obtain a second training sample and a third training sample, where the second training sample and the third training sample have a reference logical relationship; process the second training sample and the third training sample by adopting a preset neural network to obtain a predicted logical relationship; determine a second loss value corresponding to the reference logical relationship and the predicted logical relationship; if the second loss value is greater than or equal to a second loss value threshold, adjust a network parameter of the preset neural network; if the second loss value is less than the second loss value threshold, obtain a trained preset neural network, and the trained preset neural network is configured to simulate a logical relational symbol.

Further, as shown in FIG. 10, the electronic device also includes a firewall 101, a load balancer 102, a communication component 106, a power supply component 107 and other components. Only some components are shown schematically in FIG. 10, which does not mean that the electronic device only includes the components shown in FIG. 10.

In the electronic device provided by an embodiment of the present disclosure, since a prediction model includes a plurality of rule chains, each rule chain has a corresponding prediction result and an analysis basis, when attribute data meets an analysis basis corresponding to a target rule chain, a target prediction result can be determined and a corresponding target analysis basis for obtaining the target prediction result can be determined.

Correspondingly, an embodiment of the present disclosure also provides a computer-readable storage medium storing a computer program or an instruction, which, when the computer program or the instruction executed by a processor, causes the processor to implement the steps in the method shown in FIG. 2, FIG. 6 or FIG. 8.

Correspondingly, an embodiment of the present disclosure also provides a computer program product, including a computer program or an instruction, which, when executed by a processor, cause the processor to implement the steps in the method shown in FIG. 2, FIG. 6 or FIG. 8.

The communication component in FIG. 10 is configured to facilitate wired or wireless communication between a device where the communication component is located and other device(s). The device where the communication component is located can access a wireless network based on a communication standard, such as WiFi, a mobile communication network such as 2G, 3G, 4G/LTE, 5G, or a combination thereof. In an exemplary embodiment, the communication component receives a broadcast signal or broadcast related information from an external broadcast management system via a broadcast channel. In an exemplary embodiment, the communication component further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

The power supply component in FIG. 10 provides power for various components of the device where the power supply component is located. The power supply component can include a power management system, one or more power supplies, and other components associated with generating, managing and distributing power for the device where the power supply component is located.

It should be understood by those skilled in the art that embodiments of the present disclosure can be provided as a method, a system, or a computer program product. Therefore, the present disclosure can take a form of an entirely hardware embodiment, an entirely software embodiment, or an embodiment combining software and hardware aspects. Furthermore, the present disclosure can take the form of a computer program product embodied on one or more computer usable storage medium (including but not limited to disk storage, CD-ROM, optical storage, etc.) containing a computer usable program code therein.

The present disclosure is described with reference to a flowchart and/or a block diagram of a method, a device (system) and a computer program product according to an embodiment of the present disclosure. It should be understood that each flow and/or block in the flowchart and/or block diagram, and a combination of the flow and/or block in the flowchart and/or block diagram can be implemented by computer program instructions. These computer program instructions may be provided to a processor of a general-purpose computer, special-purpose computer, embedded processor or other programmable data processing device to produce a machine, such that the instructions which are executed by the processor of the computer or other programmable data processing device produce an apparatus for implementing a function specified in one or more flows in the flowchart and/or one or more blocks in the block diagram.

These computer program instructions may also be stored in a computer-readable memory that can direct a computer or other programmable data processing device to function in a particular manner, such that the instructions stored in the computer-readable memory produce an article of manufacture including an instruction mean that implements a function specified in one or more flows in the flowchart and/or one or more blocks in the block diagram.

These computer program instructions may also be loaded onto a computer or other programmable data processing device, such that a series of operational steps are performed on the computer or other programmable device to produce a computer-implemented process, such that the instructions executed on the computer or other programmable device provide steps for implementing a function specified in one or more flows in the flowchart and/or one or more blocks in the block diagram.

In a typical configuration, a computing device includes one or more processors (CPU), an input/output interface, a network interface, and a memory.

The memory may include a non-permanent memory, a random access memory (RAM) and/or a nonvolatile memory in computer-readable medium, such as a read-only memory (ROM) or a flash memory. A memory is an example of a computer-readable medium.

The computer-readable medium, including a permanent and non-permanent, removable and non-removable media, can store information by any method or technology. The information can be a computer-readable instruction, a data structure, and a module of a program or other data. Examples of storage medium for a computer include, but not limited to a phase-change memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technologies, CD-ROM, and a digital versatile disc (DVD), or other optical storage, a magnetic cassette, a magnetic tape magnetic disk storage or other magnetic storage device or any other non-transmission medium, can be used to store information that can be accessed by a computing device. According to the definition in this specification, a computer-readable medium does not include a transitory media (transitory media), such as a modulated data signal and carrier wave.

It should also be noted that the terms “include”, “including” or any other variation thereof are intended to cover non-exclusive inclusion, so that a process, method, commodity or device including a series of elements includes not only those elements, but also other elements not explicitly listed, or elements inherent to such process, method, commodity or device. Without more restrictions, the element defined by the sentence “including a . . . ” does not exclude that there are other identical elements in the process, method, commodity or device including the element.

The above are only embodiments of the present disclosure, and don't intend to limit the present disclosure. Various modifications and variations of the present disclosure will occur to those skilled in the art. Any modification, equivalent substitution, improvement, etc. made within the spirit and principle of the present disclosure should be falling into the scope of the claims of the present disclosure.

1. A data processing method, comprising:
acquiring attribute data of a target object, wherein the target object comprises one of an image, a text, a voice or a user;
inputting the attribute data into a prediction model for analysis to obtain a target prediction result corresponding to the attribute data and a target analysis basis for obtaining the target prediction result, wherein the prediction model comprises a plurality of rule chains, each of which has a corresponding prediction result and an analysis basis, the target prediction result is determined according to a prediction result corresponding to a target rule chain, the target analysis basis is determined according to an analysis basis corresponding to the target rule chain, and the attribute data meets the analysis basis corresponding to the target rule chain.

2. The data processing method according to claim 1, wherein the rule chain comprises a plurality of processing nodes connected in series, each of the processing node correspondingly represents an atomic proposition, and the inputting the attribute data into a prediction model for analysis to obtain a target prediction result corresponding to the attribute data and a target analysis basis for obtaining the target prediction result comprises:
determining a target rule chain meeting a preset condition among the plurality of rule chains according to the attribute data, wherein the preset condition is that a prediction result corresponding to the target rule chain can be obtained after the attribute data is input into the target rule chain for data processing;
determining the target prediction result according to the prediction result corresponding to the target rule chain;
determining the target analysis basis according to the attribute data and an atomic proposition of each processing node of the target rule chain.

3. The data processing method according to claim 2, wherein the processing node comprises a logical relational symbol and reference data, and the plurality of rule chains are in a parallel structure, and the determining a target rule chain meeting a preset condition among the plurality of rule chains according to the attribute data comprises:
inputting the attribute data into a processing node for data processing to obtain an output result;
if the output result indicates that a target logical relationship between the attribute data and the reference data is the same as a reference logical relationship, determining the processing node as a target processing node, and the reference logical relationship is a logical relationship represented by the logical relational symbol;
determining the target rule chain according to the target processing node, and all processing nodes on the target rule chain being the target processing nodes.

4. The data processing method according to claim 3, wherein the plurality of rule chains are in a graphic structure or a tree structure, a processing node in the graphic structure or the tree structure is a first processing node, an intermediate processing node or a tail processing node, an output end of the first processing node and an output end of the intermediate processing node both are connected with two processing nodes, and an input end of the intermediate processing nodes and an input end of the tail processing node both are connected with one processing node, the target rule chain comprises the first processing node, a target intermediate processing node and a target tail processing node, and the determining a target rule chain meeting a preset condition among the plurality of rule chains according to the attribute data comprises:
inputting the attribute data into a processing node for data processing to obtain an output result;
determining the target intermediate processing node according to an output result of the first processing node, wherein when the output result of the first processing node indicates that the target logical relationship and the reference logical relationship are the same, one intermediate processing node connected with the first processing node is taken as the target intermediate processing node, and when the output result of the first processing node indicates that the target logical relationship and the reference logical relationship are different, another intermediate processing node connected with the first processing node is taken as the target intermediate processing node;
determining the target tail processing node according to the output result of the target intermediate processing node.

5. The data processing method according to claim 3, wherein the logical relational symbol is simulated by a preset neural network, and the inputting the attribute data into a processing node for data processing to obtain an output result comprises:
inputting the attribute data and the reference data into the preset neural network for data processing to output a target logical relationship;
determining the output result according to the target logical relationship and the reference logical relationship corresponding to the logical relational symbol.

6. The data processing method according to claim 3, wherein the determining the target analysis basis according to the attribute data and an atomic proposition of each processing node of the target rule chain comprises:
determining the target analysis basis according to the attribute data, a target logical relationship and reference data corresponding to the target processing node.

7. The data processing method according to claim 1, wherein the prediction model is trained in the following way:
acquiring a first training sample and label data, wherein the first training sample comprises sample attribute data of a sample object, and a sample label represents a category or a potential characteristic of the sample object;
inputting the sample attribute data into a prediction model for analysis to obtain prediction result data, wherein the prediction model comprises a rule chain, and the rule chain comprises a plurality of processing nodes connected in series, and each processing node comprises a logical relational symbol and reference data, wherein the logical relational symbol is obtained by a simulation of a corresponding preset neural network;
determining a first loss value of the label data and the prediction result data;
if the first loss value is greater than or equal to a first loss value threshold, adjusting a connection relationship between the processing nodes and the reference data;
if the first loss value is less than the first loss value threshold, obtaining a trained prediction model.

8. The data processing method according to claim 7, wherein the logical relational symbol is trained in the following ways:
acquiring a second training sample and a third training sample, wherein the second training sample and the third training sample have the reference logical relationship;
processing the second training sample and the third training sample by adopting a preset neural network to obtain a predicted logical relationship;
determining a second loss value corresponding to the reference logical relationship and the predicted logical relationship;
if the second loss value is greater than or equal to a second loss value threshold, adjusting a network parameter of the preset neural network;
if the second loss value is less than the second loss value threshold, obtaining a trained preset neural network, and the trained preset neural network is configured to simulate the logical relational symbol.

9. (canceled)

10. An electronic device, comprising a processor, a memory and a computer program stored in the memory and executable on the processor, wherein the processor, when executing the computer program, implements the following operations:
acquiring attribute data of a target object, wherein the target object comprises one of an image, a text, a voice or a user;
inputting the attribute data into a prediction model for analysis to obtain a target prediction result corresponding to the attribute data and a target analysis basis for obtaining the target prediction result, wherein the prediction model comprises a plurality of rule chains, each of which has a corresponding prediction result and an analysis basis, the target prediction result is determined according to a prediction result corresponding to a target rule chain, the target analysis basis is determined according to an analysis basis corresponding to the target rule chain, and the attribute data meets the analysis basis corresponding to the target rule chain.

11. The data processing method according to claim 4, wherein the logical relational symbol is simulated by a preset neural network, and the inputting the attribute data into a processing node for data processing to obtain an output result comprises:
inputting the attribute data and the reference data into the preset neural network for data processing to output a target logical relationship;
determining the output result according to the target logical relationship and the reference logical relationship corresponding to the logical relational symbol.

12. The data processing method according to claim 4, wherein the determining the target analysis basis according to the attribute data and an atomic proposition of each processing node of the target rule chain comprises:
determining the target analysis basis according to the attribute data, a target logical relationship and reference data corresponding to the target processing node.

13. The data processing method according to claim 2, wherein the prediction model is trained in the following way:
acquiring a first training sample and label data, wherein the first training sample comprises sample attribute data of a sample object, and a sample label represents a category or a potential characteristic of the sample object;
inputting the sample attribute data into a prediction model for analysis to obtain prediction result data, wherein the prediction model comprises a rule chain, and the rule chain comprises a plurality of processing nodes connected in series, and each processing node comprises a logical relational symbol and reference data, wherein the logical relational symbol is obtained by a simulation of a corresponding preset neural network;
determining a first loss value of the label data and the prediction result data;
if the first loss value is greater than or equal to a first loss value threshold, adjusting a connection relationship between the processing nodes and the reference data;
if the first loss value is less than the first loss value threshold, obtaining a trained prediction model.

14. The data processing method according to claim 3, wherein the prediction model is trained in the following way:
acquiring a first training sample and label data, wherein the first training sample comprises sample attribute data of a sample object, and a sample label represents a category or a potential characteristic of the sample object;
inputting the sample attribute data into a prediction model for analysis to obtain prediction result data, wherein the prediction model comprises a rule chain, and the rule chain comprises a plurality of processing nodes connected in series, and each processing node comprises a logical relational symbol and reference data, wherein the logical relational symbol is obtained by a simulation of a corresponding preset neural network;
determining a first loss value of the label data and the prediction result data;
if the first loss value is greater than or equal to a first loss value threshold, adjusting a connection relationship between the processing nodes and the reference data;
if the first loss value is less than the first loss value threshold, obtaining a trained prediction model.

15. The data processing method according to claim 4, wherein the prediction model is trained in the following way:
acquiring a first training sample and label data, wherein the first training sample comprises sample attribute data of a sample object, and a sample label represents a category or a potential characteristic of the sample object;
inputting the sample attribute data into a prediction model for analysis to obtain prediction result data, wherein the prediction model comprises a rule chain, and the rule chain comprises a plurality of processing nodes connected in series, and each processing node comprises a logical relational symbol and reference data, wherein the logical relational symbol is obtained by a simulation of a corresponding preset neural network;
determining a first loss value of the label data and the prediction result data;
if the first loss value is greater than or equal to a first loss value threshold, adjusting a connection relationship between the processing nodes and the reference data;
if the first loss value is less than the first loss value threshold, obtaining a trained prediction model.

16. The data processing method according to claim 13, wherein the logical relational symbol is trained in the following ways:
acquiring a second training sample and a third training sample, wherein the second training sample and the third training sample have the reference logical relationship;
processing the second training sample and the third training sample by adopting a preset neural network to obtain a predicted logical relationship;
determining a second loss value corresponding to the reference logical relationship and the predicted logical relationship;
if the second loss value is greater than or equal to a second loss value threshold, adjusting a network parameter of the preset neural network;
if the second loss value is less than the second loss value threshold, obtaining a trained preset neural network, and the trained preset neural network is configured to simulate the logical relational symbol.

17. The data processing method according to claim 14, wherein the logical relational symbol is trained in the following ways:
acquiring a second training sample and a third training sample, wherein the second training sample and the third training sample have the reference logical relationship;
processing the second training sample and the third training sample by adopting a preset neural network to obtain a predicted logical relationship;
determining a second loss value corresponding to the reference logical relationship and the predicted logical relationship;
if the second loss value is greater than or equal to a second loss value threshold, adjusting a network parameter of the preset neural network;
if the second loss value is less than the second loss value threshold, obtaining a trained preset neural network, and the trained preset neural network is configured to simulate the logical relational symbol.

18. The data processing method according to claim 15, wherein the logical relational symbol is trained in the following ways:
acquiring a second training sample and a third training sample, wherein the second training sample and the third training sample have the reference logical relationship;
processing the second training sample and the third training sample by adopting a preset neural network to obtain a predicted logical relationship;
determining a second loss value corresponding to the reference logical relationship and the predicted logical relationship;
if the second loss value is greater than or equal to a second loss value threshold, adjusting a network parameter of the preset neural network;
if the second loss value is less than the second loss value threshold, obtaining a trained preset neural network, and the trained preset neural network is configured to simulate the logical relational symbol.

19. The electronic device according to claim 10, wherein the rule chain comprises a plurality of processing nodes connected in series, each of the processing node correspondingly represents an atomic proposition; the processor, when executing the computer program, further implements the following operations:
determining a target rule chain meeting a preset condition among the plurality of rule chains according to the attribute data, wherein the preset condition is that a prediction result corresponding to the target rule chain can be obtained after the attribute data is input into the target rule chain for data processing;
determining the target prediction result according to the prediction result corresponding to the target rule chain;
determining the target analysis basis according to the attribute data and an atomic proposition of each processing node of the target rule chain.

20. The electronic device according to claim 19, wherein the processing node comprises a logical relational symbol and reference data, and the plurality of rule chains are in a parallel structure; the processor, when executing the computer program, further implements the following operations:
inputting the attribute data into a processing node for data processing to obtain an output result;
if the output result indicates that a target logical relationship between the attribute data and the reference data is the same as a reference logical relationship, determining the processing node as a target processing node, and the reference logical relationship is a logical relationship represented by the logical relational symbol;
determining the target rule chain according to the target processing node, and all processing nodes on the target rule chain being the target processing nodes.

21. The electronic device according to claim 20, wherein the plurality of rule chains are in a graphic structure or a tree structure, a processing node in the graphic structure or the tree structure is a first processing node, an intermediate processing node or a tail processing node, an output end of the first processing node and an output end of the intermediate processing node both are connected with two processing nodes, and an input end of the intermediate processing nodes and an input end of the tail processing node both are connected with one processing node, the target rule chain comprises the first processing node, a target intermediate processing node and a target tail processing node; the processor, when executing the computer program, further implements the following operations:
inputting the attribute data into a processing node for data processing to obtain an output result;
determining the target intermediate processing node according to an output result of the first processing node, wherein when the output result of the first processing node indicates that the target logical relationship and the reference logical relationship are the same, one intermediate processing node connected with the first processing node is taken as the target intermediate processing node, and when the output result of the first processing node indicates that the target logical relationship and the reference logical relationship are different, another intermediate processing node connected with the first processing node is taken as the target intermediate processing node;
determining the target tail processing node according to the output result of the target intermediate processing node.
